(19) United States
(12) Patent Application Publication
(10) Pub. No.: US 2009/0256481 A1
(43) Pub. Date: Oct. 15, 2009

(54) STAND ALONE LAMP FILAMENT PREHEAT CIRCUIT FOR BALLAST

(75) Inventors: Antony Neethi Manickam Kalugumalai, Tamil Nadu (IN); Ashish Kumar Gupta, Up (IN)

Correspondence Address: SENNIGER POWERS LLP (OSR), 100 NORTH BROADWAY, 17TH FLOOR, ST. LOUIS, MO, 63102, US

(73) Assignee: OSRAM SYLVANIA Inc., Danvers, MA (US)

(21) Appl. No.: 12/177,590

(22) Filed: Jul. 22, 2008

(30) Foreign Application Priority Data
Apr. 11, 2008 (IN) 951/DEL/2008

(51) Int. Cl. H01J 7/44

(52) U.S. Cl. 315/46

(57) ABSTRACT

A lamp filament preheating circuit using modified flyback topology which gives pulsating AC in the secondary of the flyback transformer. The circuit may be controller based or implemented by a monoshot and astable multivibrator. A self-oscillation, parallel resonant current fed half bridge inverter circuit may include an arc sensing circuit.

### FIELD OF THE INVENTION

The present invention generally relates to a lamp filament preheating circuit and, in particular, a controller based independent fluorescent lamp filament preheating circuit and, optionally, circuit for anti-arcing.

### BACKGROUND OF THE INVENTION

Electronic ballasts for gas discharge lamps are often classified into two groups according to how the lamps are ignited—preheat and instant start. In preheat ballasts, the lamp filaments are preheated at a relatively high level (e.g., 7 volts peak) for a limited period of time (e.g., one second or less) before a moderately high voltage (e.g., 500 volts peak) is applied across the lamp in order to ignite the lamp. In instant start ballasts, the lamp filaments are not preheated, so a higher starting voltage (e.g., 1000 volts peak) is required in order to ignite the lamp. It is generally acknowledged that instant start operation offers certain advantages, such as the ability to ignite the lamp at a lower ambient temperatures and greater energy efficiency (i.e., light output per watt) due to no expenditure of power on filament heating during normal operation of the lamp. On the other hand, instant start operation usually results in considerably lower lamp life than preheat operation.

Because a substantial amount of power is unnecessarily expended on heating the lamp filaments during normal operation of the lamp, it is desirable to have ballasts in which filament power is minimized or eliminated once the lamp has ignited. Currently, there are at least three approaches for achieving this goal.

A first approach, which may be called the “passive” method, heats the filaments via windings on a transformer that also provides the high voltage for igniting the lamp. An acknowledged drawback of this approach is a limit on the degree to which filament heating power may be reduced once the lamp ignites and begins to operate; a detailed discussion of the difficulties with this approach is provided in the “Background of the Invention” section of U.S. Pat. No. 5,998,930, the relevant portions of which are incorporated herein by reference.

A second approach, which is common in so-called “programmed start” products, employs an inverter that is operated at one frequency in order to preheat the lamp filaments, then “swept” to another frequency in order to ignite and operate the lamp. Because this approach is difficult and/or costly to implement in ballasts having self-oscillating type inverters, it is usually employed only in ballasts having driven type inverters. This approach has the further disadvantage of producing a significant amount of “glow current” through the lamp immediately prior to ignition. Glow current is generally considered to negatively impact the useful life of the lamp.

A third approach employs switching circuitry that disconnects the source of filament power from each of the filaments after the lamp ignites. This approach tends to be rather costly to implement, especially in ballasts that power multiple lamps because multiple switching circuits are required (i.e., one for each filament or each pair of parallel-connected filaments).

All of the aforementioned approaches are largely limited in function to filament heating and do not provide any separate benefits, such as automatic relamping capability or prevention of the high voltages, currents, and power dissipation that generally occurs following lamp removal or failure. Because ballasts that implement these approaches generally require separate, dedicated circuitry in order to accommodate relamping and protect the ballast from damage due to lamp removal or failure, the resulting ballasts tend to be functionally and structurally complex.

What is needed, therefore, is a ballast in which the filaments are properly preheated prior to lamp ignition. In addition, the ballast should detect any arcing condition and should shut down. The circuit sensitivity should be high enough to detect the arcing condition and allow ballast to operate in the normal condition. A ballast with these attributes would represent a significant advance over the prior art.

### SUMMARY OF THE INVENTION

In one form, the invention is preheating circuit which modifies the flyback topology of a ballast leading to pulsating AC in the secondary of the flyback transformer. This is in contrast to the present flyback topology, which does not give pulsating AC in the output. The circuit may include a controller or it may be implemented by a monoshot and astable multivibrator. In proposed program start ballast topology, the inverter is started after the lamp filament preheating so that the lamp ignites after preheating. A self-oscillation, parallel resonant current fed half bridge inverter circuit may include an arc sensing circuit.

Other objects and features will be in part apparent and in part pointed out hereinafter.

### BRIEF DESCRIPTION OF THE DRAWINGS

FIG. 1 is a block diagram of one embodiment of a filament preheating circuit according to the invention.

FIG. 2 is a schematic circuit diagram of one embodiment of a filament preheating circuit according to the invention.

FIG. 3 is a block diagram of one embodiment of a filament heating circuit with preheating according to the invention.

FIG. 4 is a schematic circuit diagram of one embodiment of a filament heating circuit with arc sensing according to the invention.

Corresponding reference characters indicate corresponding parts throughout the drawings.

### DESCRIPTION OF THE PREFERRED EMBODIMENTS

In one embodiment, the present invention is an independent fluorescent lamp filament preheating circuit. It is contemplated that this circuit would operate independently of any normal ballast operation and would be compatible with most if not all types of ballasts. For example, this circuit may be used with in conjunction with instant start self-oscillating topology ballasts to convert the ballast into a program start ballast. Alternatively, or in addition, this circuit may be used for lamp filament heating during dimming operation of a ballast.

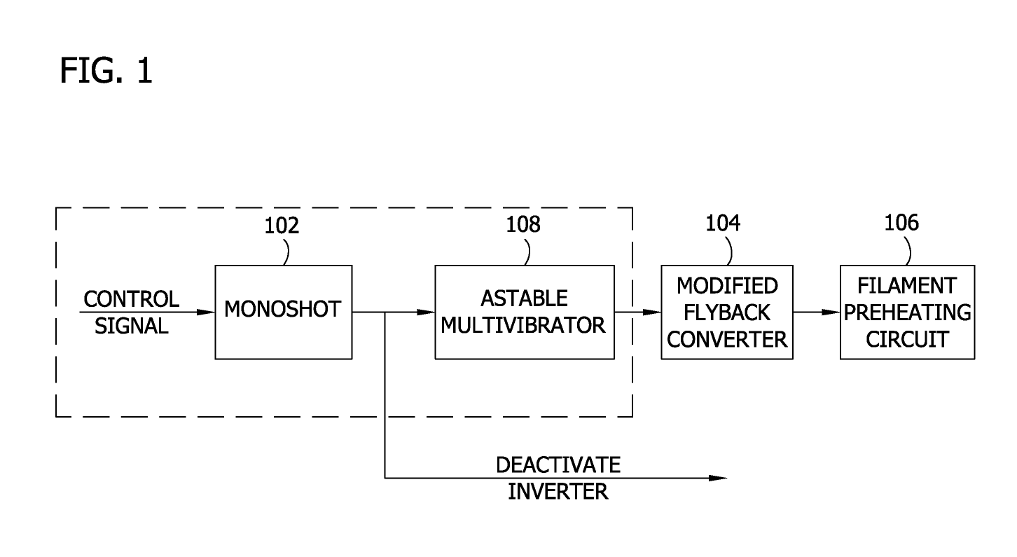

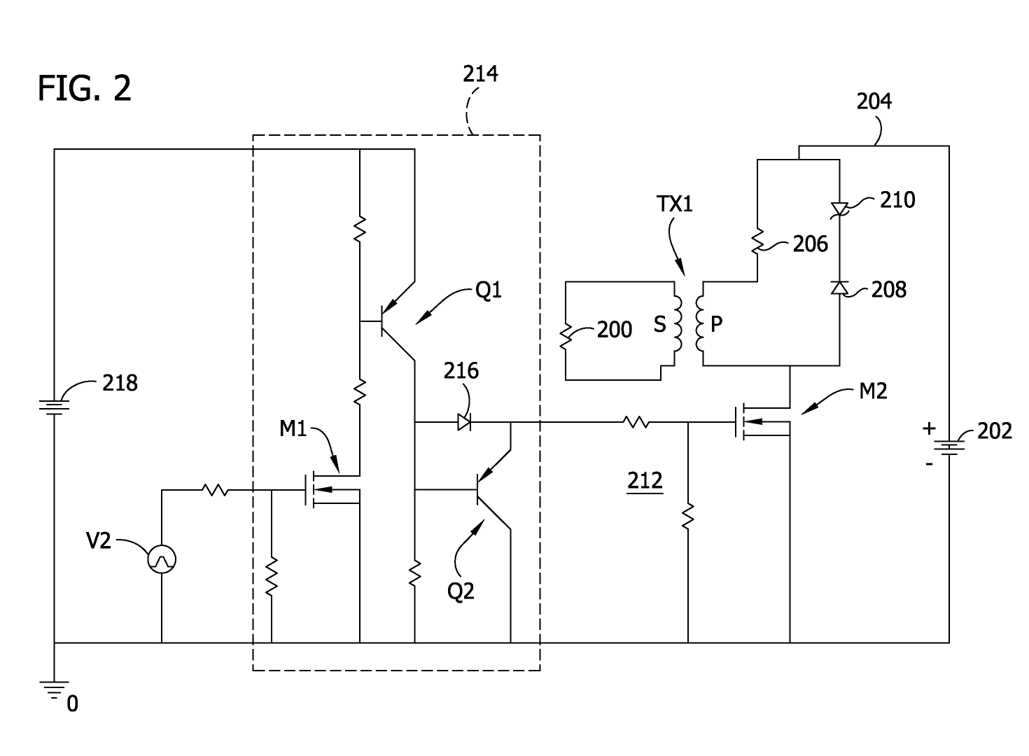

FIG. 1 is a block diagram of one embodiment of a filament preheating circuit according to the invention. The half bridge self-oscillation aspects of normal lamp operation are not shown in FIG. 1 and FIG. 2. A filament preheating circuit 106 is energized by a flyback converter 104 which has been modified. When power to a de-energized ballast is provided, a control signal indicative of the switched ON power activates a monoshot circuit 102 (e.g., a flip-flop circuit) which generates a single pulse for deactivating (e.g., inhibiting) a half bridge inverter. The single pulse signals an astable multivibrator circuit 108 which applies pulses to the modified flyback converter 104 causing the converter 104 to generate a high frequency preheating voltage in a filament transformer of the filament heating circuit 106 for preheating the lamp filament.

After the desired preheating time, the single pulse of the monoshot 102 goes low or terminates, which allows the inverter to operate and provides a signal to the astable multivibrator to discontinue operation of the astable multivibrator circuit 108 and the modified flyback converter 104 so that the preheating of the filament ends. As a result, the lamp filament is preheated before lamp ignition. As noted below, the monoshot 102 and multivibrator circuit 108 may be replaced by a controller or other circuit to generate the control and logic signals.

FIG. 2 illustrates one embodiment of a circuit diagram of the lamp filament preheating circuit according to the invention. A voltage source V2 simulates an inhibit signal of a microcontroller. This microcontroller inhibit signal is used as a control signal for preheating a lamp filament 200 from a DC supply 202.

A primary winding of a filament transformer TX1 is connected to a DC rail 204 through a high frequency switching device such as a preheat MOSFET M2. A resistor 206 is used to limit the fault mode current through the preheat MOSFET M2. A diode 208 and a transient voltage suppressor such as a zener diode 210 operate as a snubber circuit for the preheat MOSFET M2 to suppress voltage transient spikes. As a result, embodiments of the invention provide a preheating circuit which modifies the flyback topology of the ballast, leading to pulsating AC in the secondary of the flyback transformer. This is in contrast to the present flyback topology, which does not include any such pulsating AC. Pulsating AC appears in the secondary because no diode is included in the secondary which would normally take care of changes in the voltage polarity in the primary winding, which occur during turn OFF of the switch. As noted below the circuit may be controller based, such as including a microcontroller. Alternatively, one embodiment of the invention may be implemented without a programmable controller, such as illustrated in FIG. 1.

As the preheat MOSFET M2 operates to open and close at high frequency to selectively energize the primary winding of the transformer TX1, a voltage is induced across the primary winding of transformer TX1. A corresponding induced voltage develops across the secondary winding of the transformer TX1 which preheats the lamp filament 200. In this circuit, only one lamp filament 200 is shown to avoid the circuit complexity; however, it is contemplated that individual transformer windings may be used for preheating different lamp filaments. Optionally, a capacitor (not shown in FIG. 2) in series of the filament 200 may be added to control filament current.

Due to low output voltage and low sourcing/sinking capability of a microcontroller, it is contemplated in one embodiment that the preheat MOSFET M2 would be driven indirectly. Thus, a level translator 212 and a buffer 214 of the power circuit may be used to drive the preheat MOSFET M2 to increase reliable operation of the circuit. In FIG. 2, the microcontroller (e.g., represented by voltage V2) drives a MOSFET switch M1 which in one embodiment has low gate capacitance (e.g., ≈25 pF) to accommodate microcontrollers which are capable of direct driving of a capacitive load of about ≈50 pF. The drain of MOSFET switch M1 drives a switch Q1 of the inverter Q1, Q2. With this arrangement, MOSFET switch M1 inhibits operation of the inverter Q1, Q2 and increases the strength of the signal driving the preheat MOSFET M2 so that the resultant signal driving the preheat MOSFET M2 is sufficient. A diode 216 and a switch Q2 assist in fast turn off of the preheat MOSFET M2 to reduce the turn OFF losses.

Thus, FIGS. 1 and 2 illustrate embodiments of a circuit for preheating a filament 200 of a lamp according to the invention. In one embodiment, a filament preheating circuit, such as circuit 106 or transformer TX1, is connected to the filament 200. A power circuit including an inverter (e.g., switches Q1 and Q2) is adapted to be connected to a power supply 202 and connected to the filament preheating circuit 106, TX1 for energizing the filament preheating circuit 106, TX1. An oscillating circuit, such as flyback converter 104 or preheat MOSFET M2 and related circuitry, is connected to the filament preheating circuit 106, TX1 to induce a high frequency voltage applied to the filament 200 to preheat the filament 200. A control circuit, such as monoshot 102 and astable multivibrator 108 or switch M1 and related circuitry, is included wherein the monoshot 102 selectively inhibits operation of the inverter (Q1, Q2) during start up of the power circuit so that the flyback converter 104 induces the high frequency voltage to the filament 200 and preheats the filament 200 during start up of the power circuit.

The topology according to the invention provides several advantages over conventional half-bridge topology based pre-heating circuits. In embodiments of the invention, the topology can be implemented with fewer components and at a lower cost effective price. For example, the pre-heating signal with cut-off may be generated by a low cost microcontroller (or from any other low cost dual timer). In addition, low cost, discrete components may be used in the gate drive circuit to drive the preheat MOSFET M2. This eliminates the need for a costly MOSFET gate driver IC to drive the MOSFET. Also, only one power MOSFET may be used for preheating as well as lamp filament heating cut-off while conventional half-bridge based pre-heating used two power MOSFETs and a high side driver IC to drive the upper side MOSFET.

In a program start ballast topology as shown in FIGS. 1 and 2, the inverter should start after the lamp filament preheating to increase the life of the lamp. Hence, the lamp would not ignite until after preheating of the lamp filaments. Normally, in this topology, a starting pulse is generated through an AC diode (i.e., a DIAC). To insure this scenario, the microcontroller supplies an inhibit signal to prevent the voltage rise across the DIAC. After stabilization of the DC rail, the microcontroller provides the logic signal for filament preheating. After preheating of the lamp filament, the microcontroller releases the DIAC and so that the inverter starts its normal operation to ignite the lamp.

In embodiments of the invention, the topology can be implemented to provide low lamp filament voltage in normal operation. Lamp filament voltage during lamp operation is very low as compared to other half bridge filament cutoff topology. In this topology of the invention, the transformer may be connected to the DC positive rail, which has a very low ripple voltage. In contrast, conventional half-bridge topology based pre-heating connects the filament heating transformer between the half-bridge mid-point to DC Bus negative rail through a pre-heating cut-off MOSFET. In conventional half-bridge topology, the output capacitance of the MOSFET allows a small current in the primary of the filament winding to flow which causes filament losses and reduces the efficiency.

In embodiments of the invention, the topology can be implemented as an independent, stand-alone design. It may be adapted to any existing instant start topology or any other topology, which does not have a lamp filament pre-heating function. Also, the microcontroller has additional I/O ports for seamless integration. Any additional logic signal, such as for shut down, dimming or any other function can be easily controlled and adapted. In embodiments of the invention, the topology can be implemented so that pre-heating parameters such pre-heat time, frequency and duty cycle are controlled by software instructions which operate the microcontroller.

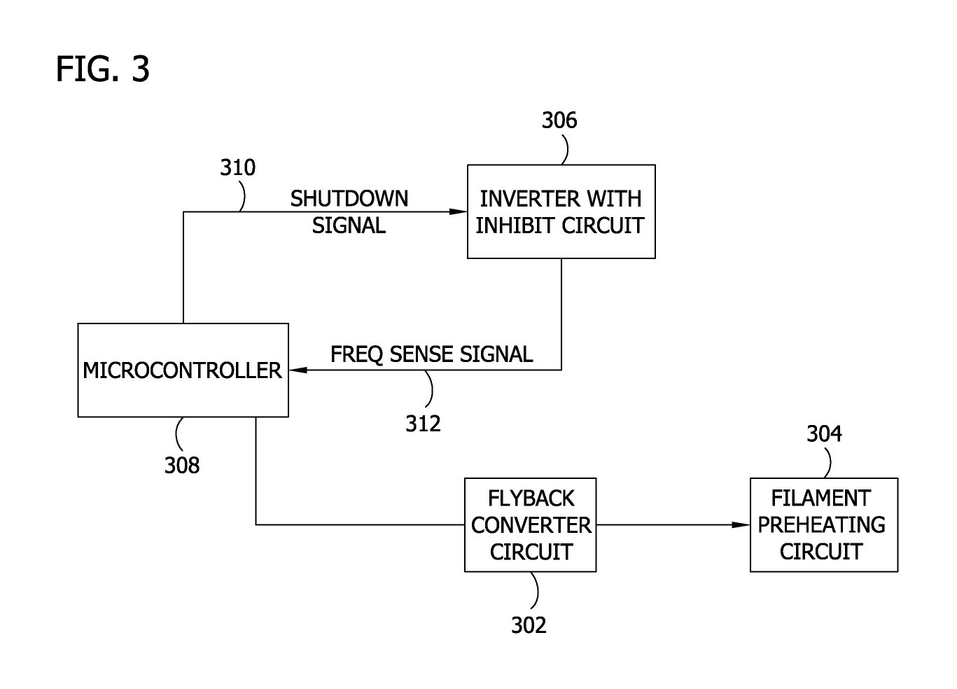

FIG. 3 is a block diagram of one embodiment of a filament heating circuit with preheating according to the invention. A flyback converter circuit 302 is connected to a filament preheating circuit 304. The flyback converter circuit 302 supplies power to the filament preheating circuit 304 is controlled by a microcontroller 308. Optionally, an inverter 306 for powering a lamp (not shown) may include an inhibit circuit for delaying startup of the inverter 306 and delaying ignition of the filament. Alternatively, the microcontroller 308 may provide a shutdown signal 310 for inhibiting the inverter 306. Alternatively and in addition, the microcontroller 308 may provide the shutdown signal 310 for inhibiting the inverter 306 in response to detecting a change in frequency of the inverter operation, as indicated by frequency sense signal 312. The change in frequency may be indicative of arcing, as noted below.

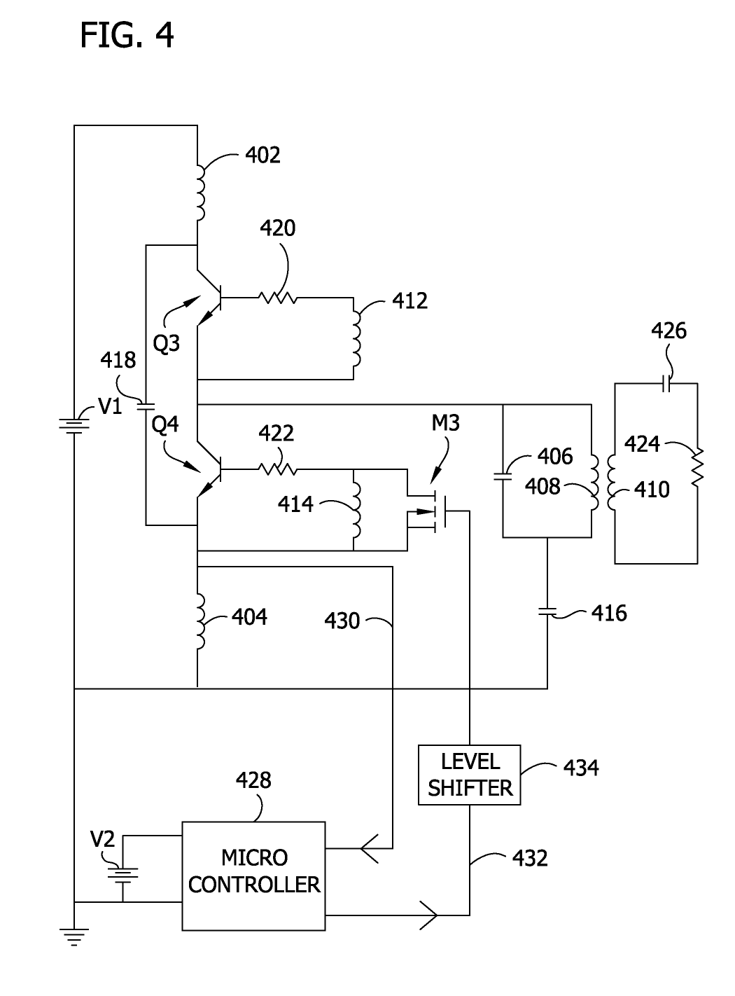

FIG. 4 is a schematic circuit diagram of one embodiment of a filament heating circuit with arc sensing according to the invention. According to UL 935, an electronic ballast intended for commercial cabinets and marked “Type CC” shall comply with the arcing test. The ballast should detect the arcing condition and should be shut down before cheesecloth catches the fire. The circuit sensitivity should be high enough to detect the arcing condition and allow ballast to operate in the normal condition. Embodiments of the invention comply with these requirements.

FIG. 4 shows one circuit diagram of the self-oscillation parallel resonant current fed half bridge inverter circuit and arc sensing circuit. In this embodiment of the invention, inverter switches Q3 and Q4 are in series with windings of tightly coupled current limit chokes 402 and 404 in series with the switches. A capacitor 406 coupled to an inductance 408 of a primary winding of a filament transformer form an LC circuit for generating the self-oscillations. A secondary winding 410 is used to step up a resonant tank voltage applied to the LC circuit while windings 412 and 414 provide a base signal to the inverter switches Q3 and Q4. A capacitor 416 acts as a DC blocking capacitor and a capacitor 418 suppresses spikes across the switches Q3 and Q4.

Resistors 420 and 422 act as base drive resistance. Lamp 424 presents an impedance represented by a resistor and a capacitor 426 is a ballasting capacitor which is used to limit the current though lamp 424. Voltage source V1 is used to represent the DC voltage. In the normal ballast operation, the DC voltage may regulated by power factor control section, not shown. Voltage source V2 represents a power supply for energizing a microcontroller 428. MOSFET M3 is a switch used to pull down the base of the inverter switch Q4. A level shifter 434 is used due to different ground potential. It is contemplated that any switching device may be used in place of MOSFET M3, as shown in FIG. 4.

The microcontroller 428 senses via line 430 a voltage across current limiting choke 404 and measures the frequency of the inverter Q3, Q4 operation, which is double of the half bridge frequency. The microcontroller 430 generates a signal via line 432 as a function of the sensed operating frequency of the inverter to shut down the inverter when changes the sensed frequency indicate arcing. The microcontroller shuts down the inverter by pulling down the base of the inverter switch Q4 and stopping the self-oscillations.

In operation, at start up the LC circuit 406, 408 will be disabled by shutdown signal 432 of the microcontroller and a preheat circuit, such as shown in FIG. 2, would operate to preheat the lamp filament. After start up, the inverter Q3, Q4 ignites the lamp 424 and the self-oscillation continues. In case of arcing at the load or a variation in the load, a load current changes which results in the change of the frequency of the self-oscillation. The change in the frequency of the self-oscillation is measured by the microcontroller 428 via line 430. After sensing the change in the frequency, microcontroller 430 generates the shutdown signal via line 432 to shut down the inverter by pulling down the base of the inverter switch Q4 and stopping the self-oscillations. This shuts down of the ballast.

In a self-oscillation instant start topology as shown in FIGS. 3 and 4, the gate signals of the inverter switches are generated by the self-oscillation operation of the ballast. To start the oscillations, a starting pulse is applied to the inverter to start the inverter operation. Normally, in this topology, the starting pulse is generated through an AC diode (i.e., a DIAC). As the DC rail voltage builds up, the voltage across the DIAC also increases. The DIAC turns ON as soon as DIAC voltage exceeds its limit and provides a starting pulse to the base drive of the inverter switch.

Since the circuits of FIGS. 3 and 4 employ a controller for the sensing of the arc, sensitivity of the circuit is software controllable. Thus, the circuit can be optimized for sensitivity according to the requirements of each fixture. This circuit is sensing the voltage across the current limit choke L1-B. The voltage across the L1-B is off high magnitude. It is contemplated that a filter circuit may be used to reduce the noise level in the controller sensing waveform. The self oscillation frequency can be sensed from other points, too. (For example, it can also sense the frequency from the base drive winding 414).

Thus, FIG. 3 illustrates an embodiment of a filament circuit for preheating a filament according to the invention and FIG. 4 illustrates an embodiment of normal ballast operation with arc sensing according to the invention. In general, it is contemplated that the filament preheating circuit 304 is independent of the normal self resonance circuit 406, 408 which operates the lamp 424.

Thus, the invention in at least one embodiment provides a cost effective isolated circuit to achieve a precise control of the Rh/Rc ratio of the lamp filament which can be added to the ballast topology. In some embodiments of the invention as illustrated in FIGS. 1 and 2, the programmable aspects may provide a more stable preheating circuit to cause lamp filament preheating before lamp ignition. Embodiments of the invention also provide customized lamp filament preheating circuit which can be adapted for each type of ballast according to the desired preheat time/energy requirements.

Having described the invention in detail, it will be apparent that modifications and variations are possible without departing from the scope of the invention defined in the appended claims.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary microcontroller environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules on a tangible computer readable storage medium. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the invention are achieved and other advantageous results attained.

Having described aspects of the invention in detail, it will be apparent that modifications and variations are possible without departing from the scope of aspects of the invention as defined in the appended claims.

As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A filament circuit for preheating a filament of a lamp comprising:
a filament preheating circuit connected to the filament;
a power circuit including an inverter for powering the lamp, said power circuit adapted to be connected to a power supply and connected to the filament preheating circuit for energizing the filament preheating circuit;
a flyback circuit connected to the filament preheating circuit to induce a high frequency voltage applied to the filament to preheat the filament;
a control circuit for selectively inhibiting operation of the inverter during start up of the power circuit so that the flyback circuit induces the high frequency voltage to the filament and preheats the filament during start up of the power circuit.

2. The circuit of claim 1 wherein the control circuit comprises an astable multivibrator and a monoshot providing a pulse to the multivibrator which applies pulses to the flyback circuit causing the flyback circuit to generate a high frequency preheating voltage in a filament transformer of the filament preheating circuit for preheating the filament wherein the pulse of the monoshot is applied to the power circuit to deactivate the inverter of the power circuit.

3. The circuit of claim 2 wherein when the pulse of the monoshot terminates, operation of the astable multivibrator circuit is discontinued to discontinue the preheating of the filament and wherein the terminated pulse allows the inverter to operate and energize the inverter to ignite the lamp so that the filament is preheated before lamp ignition.

4. The circuit of claim 1 wherein the control circuit comprises a controller providing a pulse to the flyback circuit which induces a high frequency preheating voltage in a filament transformer of the filament preheating circuit for preheating the filament, wherein the controller provides a signal applied to the power circuit to deactivate the inverter to prevent self oscillation of the power circuit for normal ballast operation.

5. The circuit of claim 4 wherein the flyback circuit comprises a MOSFET connected to a primary winding of a filament transformer for selectively energizing the primary winding of the filament transformer.

6. The circuit of claim 5 further comprising a snubber circuit connected to the primary winding of the filament transformer.

7. The circuit of claim 5 further comprising a capacitor in series with the filament to control filament current.

8. The circuit of claim 5 wherein the MOSFET is indirectly driven by a buffer and a level translator.

9. The circuit of claim 1 wherein the control circuit is connected to the inverter for sensing a frequency of operation of the inverter, said control circuit providing a shutdown signal to the inverter as a function of the sensed frequency.

10. A circuit for preheating a filament of a lamp comprising:
a filament preheating circuit connected to the filament; and
a flyback circuit connected to the filament preheating circuit to induce a high frequency voltage applied via the filament preheating circuit to the filament to preheat the filament.

11. The circuit of claim 10 further comprising a microcontroller connected to an inverter for sensing a frequency of operation of an inverter for powering the lamp, said microcontroller providing a shutdown signal to the inverter as a function of the sensed frequency.

12. The circuit of claim 11 wherein the microcontroller provides a pulse to the flyback circuit which induces a high frequency preheating voltage in a filament transformer of the filament preheating circuit for preheating the filament, wherein the microcontroller provides a signal applied to a power circuit to deactivate an inverter to prevent self oscillation of the power circuit for normal ballast operation.

13. The circuit of claim 10 wherein the flyback circuit comprises a MOSFET connected to a primary winding of a filament transformer for selectively energizing the primary winding of the filament transformer.

14. The circuit of claim 13 further comprising a snubber circuit connected to the primary winding of the filament transformer.

15. The circuit of claim 14 further comprising a capacitor in series with the filament to control filament current.

16. The circuit of claim 14 wherein the MOSFET is indirectly driven by a buffer and a level translator.

17. The circuit of claim 11 wherein the microcontroller is connected to the inverter for sensing a frequency of operation of the inverter, said mircocontroller providing a shutdown signal to the inverter as a function of the sensed frequency.
